(19) United States
(12) Patent Application Publication
(10) Pub. No.: US 2024/0153684 A1
(43) Pub. Date: May 9, 2024

(54) NON-ORIENTED ELECTRICAL STEEL SHEET

(71) Applicant: NIPPON STEEL CORPORATION, Tokyo (JP)

(72) Inventors: Takeaki WAKISAKA, Tokyo (JP); Yoshiaki NATORI, Tokyo (JP)

(73) Assignee: NIPPON STEEL CORPORATION, Tokyo (JP)

(21) Appl. No.: 18/284,032

(22) PCT Filed: Mar. 30, 2022
(86) PCT No.: PCT/JP2022/015948

§ 371 Date: Sep. 25, 2023

(30) Foreign Application Priority Data
Mar. 31, 2021 (JP) 2021-061752
Jun. 15, 2021 (JP) 2021-099597

(51) Int. Cl. H01F 1/147; C21D 6/00; C21D 8/12; C21D 9/46; C22C 38/00; C22C 38/02; C22C 38/04; C22C 38/06; C22C 38/08; C22C 38/12; C22C 38/14; C22C 38/16; C22C 38/28; C22C 38/34; C22C 38/60

(52) U.S. Cl. CPC H01F 1/14791; C21D 6/001; C21D 6/002; C21D 6/005; C21D 6/008; C21D 8/1222; C21D 8/1233; C21D 8/125; C21D 8/1255; C21D 8/1261; C21D 9/46; C22C 38/001; C22C 38/002; C22C 38/004; C22C 38/005; C22C 38/008; C22C 38/02; C22C 38/04; C22C 38/06; C22C 38/08; C22C 38/12; C22C 38/14; C22C 38/16; C22C 38/28; C22C 38/34; C22C 38/60; C22C 2202/02

(57) ABSTRACT

In this non-oriented electrical steel sheet, an area proportion of crystal grains having a crystal grain size of less than 200 μm is 10% or lower when a boundary with a crystal orientation difference of 2° or more and less than 15° is regarded as a crystal grain boundary in a cross section parallel to a steel sheet surface.

### TECHNICAL FIELD

The present invention relates to a non-oriented electrical steel sheet.

Priority is claimed on Japanese Patent Application No. 2021-061752, filed on Mar. 31, 2021, and Japanese Patent Application No. 2021-099597, filed on Jun. 15, 2021, the contents of which are incorporated herein by reference.

### BACKGROUND ART

In recent years, there has been an increased demand for non-oriented electrical steel sheets used as materials for motors due to a worldwide increase in demand for electric devices such as motors.

Patent Document 1 describes that roundness of a punching die cutting edge is controlled according to an elongation rate of a non-oriented electrical steel sheet in a method for producing a motor core by punching the non-oriented electrical steel sheet.

### CITATION LIST

### Patent Documents

### [Patent Document 1]

Japanese Unexamined Patent Application, First Publication No. H10-24333

### SUMMARY OF INVENTION

### Problems to be Solved by the Invention

After a non-oriented electrical steel sheet used for a stator core of a motor is punched out with a die, it is subjected to core annealing to reduce iron loss. Specifically, a rotor core is first punched out of a non-oriented electrical steel sheet, then the inner diameter of a stator core is punched out, and then the outer diameter of the stator core is punched out. By applying heat to the stator core through core annealing, residual stress and strain are released, and iron loss is reduced. Although the stator core is subjected to core annealing, the rotor core is generally not subjected to annealing in order to increase the strength.

If residual stress distribution in the stator core after the stator core is punched out with a die is non-uniform, the change in shape of the stator core due to the release of residual stress during core annealing becomes non-uniform. Accordingly, high roundness of the inner diameter of the stator core obtained before core annealing may be reduced through the core annealing. One of the causes of non-uniform residual stress distribution is, for example, structural non-uniformity of punched non-oriented electrical steel sheets.

The technique described in Patent Document 1 above controls the roundness of a punching die cutting edge according to an elongation rate of a non-oriented electrical steel sheet and controls the dimensional accuracy of a non-oriented electrical steel sheet after processing according to the dimensions of the punching die. For this reason, the technique described in Patent Document 1 does not assume that a non-oriented electrical steel sheet in which a desired dimensional accuracy can be obtained can be provided independently of the dimensions of the punching die.

Accordingly, an object of the present invention is to provide a non-oriented electrical steel sheet capable of suppressing decrease in dimensional accuracy after processing and subsequent core annealing (strain relief annealing).

### Means for Solving the Problem

The gist of the present disclosure is as follows.
(1) A non-oriented electrical steel sheet according to one embodiment of the present invention, in which an area proportion of crystal grains having a crystal grain size of less than 200 μm is 10% or lower when a boundary with a crystal orientation difference of 2° or more and less than 15° is regarded as a crystal grain boundary in a cross section parallel to a steel sheet surface.
(2) In the non-oriented electrical steel sheet according to (1) above, Inequation (1) below may be satisfied when a maximum crystal grain size when a boundary with a crystal orientation difference of 15° or more is regarded as a crystal grain boundary is regarded as D15_{MAX} and an average crystal grain size when a boundary with a crystal orientation difference of 2° or more is regarded as a crystal grain boundary is regarded as D2_{AVE} in a cross section parallel to a steel sheet surface.

D15_{MAX}/D2_{AVE}≤5.0 (1)
(3) In the non-oriented electrical steel sheet according to (1) or (2) above, Inequation (2) below may be satisfied when a boundary with a crystal orientation difference of 150 or more is regarded as a crystal grain boundary in a cross section parallel to a steel sheet surface and when a major axis length is regarded as DL and a minor axis length is regarded as DC in a shape obtained by approximating shapes of crystal grains having a crystal grain size of 200 μm or more with ellipses.

DL/DC≤5.0 (2)
(4) The non-oriented electrical steel sheet according to any one of (1) to (3) may have a chemical composition containing, by mass %, C: 0% to 0.0050%, Si: 2.00% to 3.25%, Sol. Al: 0% to 1.10%, Mn: 0% to 1.10%, P: 0% to 0.30%, S: 0% to 0.0100%, N: 0% to 0.0100%, Ti: 0% to 0.1000%, V: 0% to 0.100%, Zr: 0% to 0.100%, Nb: 0% to 0.100%, B: 0% to 0.100%, O: 0% to 0.100%, Mg: 0% to 0.100%, Ca: 0% to 0.010%, Cr: 0% to 5.000%, Ni: 0% to 5.000%, Cu: 0% to 5.000%, Sn: 0% to 0.100%, Sb: 0% to 0.100%, Ce: 0% to 0.100%, Nd: 0% to 0.100%, Bi: 0% to 0.100%, W: 0% to 0.100%, Mo: 0% to 0.100%, and Y: 0% to 0.100%, with the balance being Fe and impurities, in which a sheet thickness may be 0.10 mm to 0.35 mm, and an average crystal grain size may be 10 μm to 200 μm.

### Effects of the Invention

According to the above-described embodiment of the present invention, it is possible to provide a non-oriented electrical steel sheet capable of suppressing a decrease in dimensional accuracy after processing and subsequent core annealing (strain relief annealing).

### BRIEF DESCRIPTION OF DRAWING

FIG. 1 is a plan view showing a state in which a rotor core is inserted into a stator core.

### EMBODIMENT FOR IMPLEMENTING THE INVENTION

Hereinafter, a non-oriented electrical steel sheet according to one embodiment of the present invention and a method for manufacturing the same will be described with reference to the drawings.

After a non-oriented electrical steel sheet used for a stator core is punched out with a die into a stator core, it is subjected to heat treatment (core annealing) to reduce iron loss. By subjecting the punched steel sheet to heat treatment, residual stress and strain are released, and iron loss is reduced.

During core annealing, if residual stress distribution in the stator core after the stator core is punched out with a die is non-uniform, the change in shape of the stator core due to the release of residual stress becomes non-uniform. Accordingly, high roundness of the inner diameter of the stator core obtained before core annealing may be reduced through the core annealing.

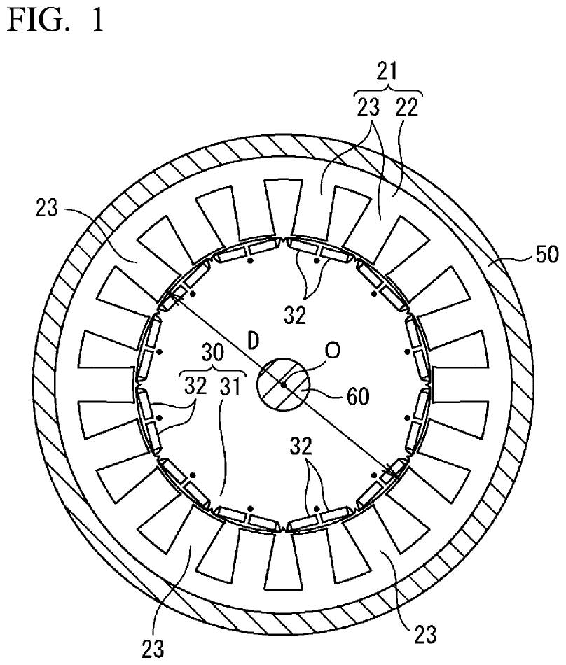

FIG. 1 is a plan view showing a state in which a rotor core is inserted into a stator core. In FIG. 1, a stator core 21 is constructed by laminating non-oriented electrical steel sheets in the direction perpendicular to the paper surface and includes a core back 22 on an outer circumferential side and a plurality of teeth 23 protruding inward from the core back 22. A rotor core 30 is inserted inside distal ends of the teeth 23. The rotor core 30 has a rotor iron core 31 and a plurality of magnets 32 which are provided on an outer circumferential side of the rotor iron core 31 and face the distal ends of the teeth 23. The outer circumference of the stator core 21 is held by the case 50. A shaft 60 penetrates through the center of the rotor iron core 31 and is fixed to the rotor iron core 31. The shaft 60 is rotatably supported by the case 50 (or another fixing member) with a center O of the shaft 60 as a rotation shaft in a state where the center O is coincident with the center of the inner diameter of the stator core 21.

In FIG. 1, the inner diameter of the stator core is specifically an inner diameter D of the distal ends of the teeth 23. When the roundness of this inner diameter D is reduced due to the change in the shape of the stator core 21 due to the above-described release of residual stress, the gap between the rotor iron core 31 and the distal ends of the teeth 23 becomes non-uniform. This increases cogging torque when the rotor core 30 rotates. The increase in cogging torque causes uneven rotation, vibration, noise, and the like. In addition, when the roundness of the inner diameter of the stator core 21 is further reduced, failures such as the rotor iron core 31 of the rotor core 30 hitting the distal ends of the teeth 23 can occur.

JIS B0621(1984) “Definitions and Designations of Geometrical Deviations” defines “roundness as a degree of deviation of a circular form from a geometrically correct circle”. In addition, regarding the designation of the roundness, it is described that “the roundness is expressed as the difference in radius between two concentric geometric circles when the distance between the two concentric circles is the shortest when a circular object is sandwiched between the two circles and is expressed as roundness_mm or roundness_μm”.

In the present embodiment, a proportion obtained by dividing the difference between the maximum value and the minimum value of the diameter of a circle by an average diameter is used as an evaluation criterion of the roundness. The maximum value of the diameter of a circle is a diameter of a larger circle out of the above-described two concentric circles described in JIS B0621(1984), and the maximum value of the diameter of a circle is a diameter of a smaller circle out of the above-described two concentric circles. In addition, the average diameter is an average value of the maximum and minimum values of the diameters of the circles. Accordingly, the evaluation criterion for the roundness of the present embodiment corresponds to a proportion obtained by dividing the roundness, which is the difference in radius between two concentric circles described in JIS B0621(1984) when the distance between the two circles is the shortest, by the average value of the radii of the two circles.

If the ratio of the difference between the maximum value and the minimum value of the inner diameter D to the average diameter exceeds 0.200%, the gap between the rotor iron core 31 and the distal ends of the teeth 23 becomes non-uniform, uneven rotation, vibration, noise, and the like are caused, and failures such as the rotor iron core 31 of the rotor core 30 hitting the distal ends of the teeth 23 may occur. Therefore, the ratio of the difference between the maximum value and the minimum value of the inner diameter D to the average diameter is set to 0.200% or less. This ratio is preferably 0.15% or less and more preferably 0.100% or less. The smaller the ratio, the more preferable it is, and therefore, there is no lower limit.

One of the causes of non-uniform residual stress distribution in the stator core is, for example, structural non-uniformity of punched non-oriented electrical steel sheets. In particular, when recrystallized structures and non-recrystallized structures coexist in a non-oriented electrical steel sheet before core annealing, the stresses remaining in the respective structures differ, resulting in differences in the degree of stress release during core annealing. As a result, there will also be differences in the shape change in each structure within the stator core. In a case where the recrystallized structures and the non-recrystallized structures are finely dispersed in the non-oriented electrical steel sheet, it is relatively difficult to detect a decrease in roundness of the inner diameter of the stator core after punching. However, in a case where the recrystallized structures and the non-recrystallized structures are unevenly distributed in the non-oriented electrical steel sheet, the stress release during core annealing is different for each unevenly distributed structure. Therefore, the roundness of the inner diameter of the stator core after punching is reduced, resulting in increased errors in motor manufacturing control.

The uneven distribution of the recrystallized structures and the non-recrystallized structures is likely to occur when the average crystal grain size of the steel sheet before final cold rolling is relatively large, or when the steel sheet before final cold rolling has a large number of crystal grains larger than the average crystal grain size. The expression “before final cold rolling” means after final annealing performed before final cold rolling. For example, a process after hot rolling and coiling corresponds to a process “before final cold rolling” in a case of a one-time cold rolling method in which hot-band annealing is not carried out, a process after hot-band annealing corresponds to a process “before final cold rolling” in a case of a one-time cold rolling method in which hot-band annealing is performed, and a process after intermediate annealing (after final annealing) corresponds to a process “before final cold rolling” in a case of a two-time cold rolling method or a multiple-time cold rolling method.

In addition, if a large number of {100}<0vw>-oriented grains exist before final cold rolling, the {100}<0vw>-oriented grains become coarsely processed grains elongated in the rolling direction during cold rolling and remain as coarse non-recrystallized structures during subsequent annealing.

In the non-oriented electrical steel sheet of the present embodiment, an area proportion of crystal grains having a crystal grain size of less than 200 μm is 10% or lower when a boundary with a crystal orientation difference of 2° or more and less than 15° is regarded as a crystal grain boundary in a cross section parallel to a steel sheet surface.

Here, the crystal orientation difference of a boundary for determining a crystal boundary is limited to a small orientation difference of less than 15°. A region observed as a relatively fine structure with a crystal grain size of less than 200 μm due to such a grain boundary with a small crystal orientation difference is, in other words, a region in which crystals having the same crystal orientation are adjacent to each other. Such regions are thought to be generated through cold rolling and annealing due to the presence of non-uniform regions in which the above-described recrystallized structures and non-recrystallized structures are unevenly distributed. That is, if the area proportion of such an area of adjacent crystals with small crystal orientation difference is small, it can be determined that there is no structure with uneven distribution of recrystallized structures and non-recrystallized structures which causes uneven distribution of residual stress as described above. In the present embodiment, this area proportion is limited to 10% or less. It is preferably less than 5%. The reason why the lower limit of the crystal orientation difference for determining the crystal grain boundary is set to 2° or more is that if the crystal orientation difference for determining the crystal grain boundary is too small (for example, about 1°), a region which is not a crystal grain boundary may be determined to be a crystal grain boundary depending on slight crystal distortion or accuracy of a measurement instrument.

The crystal orientation difference and the area proportion of crystal grains are measured as follows.

First, a sample (crystalline sample) is taken from a non-oriented electrical steel sheet with a cross section parallel to the steel sheet surface (a cross section parallel to the rolling direction and thickness direction of the steel sheet) as an observation surface, and the observation surface is polished and finished to a mirror surface. Next, the crystalline sample is placed in a scanning electron microscope (SEM) with a large inclination and is irradiated with an electron beam to obtain an electron backscatter diffraction (EBSD) pattern. The EBSD pattern is indexed and the crystal orientation is calculated while continuously collecting the EBSD pattern using a dedicated EBSD detector. The crystal structure analysis through the EBSD method is performed such that the magnification is 100 times, the number of fields of view is 5, and the size of 1 field of view is 800 μm×1,000 μm or more. The obtained data is analyzed with “OIM Analysis Version 7.3.1” (manufactured by TSL). At this time, a set of points whose crystal orientation difference between adjacent measurement points is equal to or less than a certain threshold value is regarded as one crystal grain. After determining all crystal grains in the observation field of view, the crystal orientation difference between adjacent grains and the area of each crystal grain are determined using “OIM Analysis Version 7.3.1” (manufactured by TSL).

In addition, in the present embodiment, Inequation (1) below is preferably satisfied when a maximum crystal grain size when a boundary with a crystal orientation difference of 15° or more is regarded as a crystal grain boundary is regarded as D15_{MAX} and an average crystal grain size when a boundary with a crystal orientation difference of 2° or more is regarded as a crystal grain boundary is regarded as D2_{AVE} in a cross section parallel to a steel sheet surface.

D15_{MAX}/D2_{AVE}≤5.0 Inequation (1)

This ratio (D15_{MAX}/D2_{AVE}) is an indicator of how many crystals with the same crystal orientation described above are continuously adjacent to each other and how widely they are spread. Here, the grain boundary for determining D2_{AVE} includes the grain boundary for determining D15_{MAX}. That is, the crystal grain structure for determining D2_{AVE} is a crystal structure obtained by further dividing part of the crystal grains for determining D15_{MAX} by grain boundaries with a small orientation difference. A smaller ratio indicates a situation in which coarse crystal grains when a boundary with a crystal orientation difference of 150 or more is regarded as a crystal grain boundary are finely divided at crystal grain boundaries with a small crystal orientation difference of 2° or more and less than 15°. Limiting this ratio to 5.0 or less is an indicator that there is no structure with uneven distribution of recrystallized structures and non-recrystallized structures which causes uneven distribution of residual stress as described above. D15_{MAX}/D2_{AVE} is preferably 3.0 or less.

Furthermore, in the present embodiment, Inequation (2) below is preferably satisfied when a boundary with a crystal orientation difference of 15° or more is regarded as a crystal grain boundary in a cross section parallel to a steel sheet surface and when a major axis length is regarded as DL and a minor axis length is regarded as DC in a shape obtained by approximating shapes of crystal grains having a crystal grain size of 200 μm or more with ellipses.

DL/DC≤5.0 Inequation (2)

Here, the approximation to an ellipse may be processed, for example, according to the procedure described in ““Investigation of Material Control and Material Maintenance Method by Evaluation of Strength Properties Considering Grain Shape” (Harada et al., Proceedings of 2nd Annual Conference of the Japan Society of Maintenology, p. 150)”.

For example, a test piece having a width of 15 mm and a length of 10 mm with the rolling direction as the longitudinal direction is taken from a central portion of the non-oriented electrical steel sheet in the sheet width direction, and the surface of the test piece is polished to about ½ of the sheet thickness and finished to a mirror surface. The mirror-finished sample is observed at an observation magnification of 100 times using an EBSD-equipped SEM, and its crystal structure is analyzed through EBSD measurement. The obtained data through the EBSD measurement is subjected to crystal orientation analysis with “OIM Analysis Version 7.3.1” (manufactured by TSL). In a case where a plurality of crystal grains having a crystal grain size of 200 μm or more exist in the observation region, DL/DC is calculated individually and averaged.

As described above, the present embodiment defines a situation in which coarse crystal grains are finely divided at crystal grain boundaries with a small crystal orientation difference of 2° or more and less than 15°. The “coarse crystal grains” referred to herein are crystal grains when a boundary with a crystal orientation difference of 15° or more is regarded as a crystal grain boundary.

The coarse crystal grains to be split are stretched by cold rolling during a manufacturing process, and the fine crystal grains dividing them tend to occur within these stretched regions. In other words, even if coarse crystal grains exist, if they are not stretched, the coarse crystal grains should be thought to have occurred independently of a structure with uneven distribution of recrystallized structures and non-recrystallized structures which cause uneven distribution of residual stress as described above. That is, it is an indicator that there is no structure causing uneven distribution of residual stress that would reduce the roundness. DL/DC is preferably 3.0 or less.

Regarding a base sheet for obtaining the non-oriented electrical steel sheet of the present embodiment, it is preferable that the average crystal grain size of the steel sheet before final cold rolling be 200 μm or less, and the abundance ratio of crystal grains exceeding 200 μm be 10% or less of the total grains. In addition, regarding the base sheet for obtaining the non-oriented electrical steel sheet of the present embodiment, it is preferable that the abundance ratio of {100}<0vw>-oriented grains in the steel sheet before final cold rolling be 10% or less of the total grains.

Such a base sheet is a steel sheet in which above-described uneven distribution of recrystallized structures and non-recrystallized structures is suppressed, and it is possible to avoid a decrease in roundness during punching and subsequent annealing.

The “base sheet of the non-oriented electrical steel sheet” of the present embodiment can be used as a motor core as it is. That is, although the configuration of the present embodiment is referred to as a “base sheet”, it is a steel sheet that can be assumed to be used as it is as a non-oriented electrical steel sheet that is a material for a motor core.

The above-described measurement of crystal grain sizes and the crystal orientations is performed through EBSD. Crystal grain boundaries, crystal grain sizes, and crystal orientations are determined using “OIM Analysis Version 7.3.1” (manufactured by TSL) to obtain measurement values. Typical measurement conditions are a beam diameter of 1 μm and a crystal orientation likelihood of crystal orientation of 10°. During observation, a sufficiently wide region is observed so that there is no bias in data. For example, a region containing 500 or more crystal grains to be observed is observed. In particular, in a case where it is determined that the crystals to be observed are unevenly distributed, attention should be paid to observe a sufficiently wide region to represent the overall situation without unevenness.

The chemical composition of the non-oriented electrical steel sheet according to the present embodiment contains Si and, as necessary, selective elements with the balance being Fe and impurities. Hereinafter, each element will be described.

### C: 0% to 0.0050%

Carbon (C) is an element which is contained as an impurity and deteriorates magnetic properties. Accordingly, the amount of C is set to 0.0050% or less. The amount of C is preferably 0.0030% or less. Since the amount of C is preferably small, it is unnecessary to limit the lower limit value, and the lower limit value may be 0%. However, since it is not easy to make the content thereof 0% industrially, the lower limit value may be more than 0%, or 0.0010% or more.

### Si: 2.00% to 3.25%

Silicon (Si) is an element which is effective for increasing resistivity of a steel sheet and reducing iron loss. Accordingly, the amount of Si is set to 2.00% or more. In addition, Si is an element which is effective for achieving both magnetic properties and mechanical anisotropy of a non-oriented electrical steel sheet. In this case, the amount of Si is preferably greater than 2.50%, more preferably 2.70% or more, still more preferably 2.90% or more, and still more preferably 3.00% or more. On the other hand, an excessive Si content significantly lowers magnetic flux density. Accordingly, the amount of Si is set to 3.25% or less. The amount of Si is preferably 3.20% or less and more preferably 3.15% or less.

Sol. Al: 0% to 1.10%

Aluminum (Al) is a selective element which is effective for increasing resistivity of a steel sheet and reducing iron loss, but an excessive Al content significantly lowers magnetic flux density. For this reason, the amount of Sol. Al is less than 1.10%. It is unnecessary to limit the lower limit value of Sol. Al, and the lower limit value may be 0%. However, to more reliably obtain the effects of the above-described actions, the amount of Sol. Al is preferably set to 0.10% or more. Sol. Al means acid-soluble aluminum.

### Mn: 0% to 1.10%

Manganese (Mn) is a selective element which is effective for increasing resistivity of a steel sheet and reducing iron loss. However, since Mn has a higher alloy cost than Si or Al, an increase in Mn content is economically disadvantageous. In addition, an excessive Mn content significantly lowers magnetic flux density. For this reason, the amount of Mn is set to 1.10% or less. The amount of Mn is preferably 0.90% or less. It is unnecessary to limit the lower limit value of Mn, and the lower limit value may be 0%. However, to more reliably obtain the effects of the above-described actions, the amount of Mn is preferably 0.0010% or more and more preferably 0.0100% or more.

### P: 0% to 0.30%

Phosphorus (P) is an element generally contained as an impurity. However, since it has an action of improving magnetic properties by improving a texture of a non-oriented electrical steel sheet, it may be incorporated as necessary. However, since P is also a solid-solution strengthening element, an excessive P content hardens a steel sheet and makes cold rolling difficult. For this reason, the amount of P is set to 0.30% or less. The amount of P is preferably 0.20% or less. It is unnecessary to limit the lower limit value of P, and the lower limit value may be 0%. However, to more reliably obtain the effect of the above-described action, the amount of P is preferably 0.001% or more and more preferably 0.015% or more.

### S: 0% to 0.0100%

Sulfur (S) is contained as an impurity, binds to Mn in steel to form fine MnS, inhibits growth of crystal grains during annealing and deteriorates magnetic properties of a non-oriented electrical steel sheet. For this reason, the amount of S is set to 0.0100% or less. The amount of S is preferably 0.0050% or less and more preferably 0.0030% or less. Since the amount of S is preferably small, it is unnecessary to limit the lower limit value, and the lower limit value may be 0%. However, since it is not easy to make the content thereof 0% industrially, the lower limit value may be 0.0001%.

### N: 0% to 0.0100%

Nitrogen (N) is contained as an impurity, binds to Al to form fine AlN, inhibits growth of crystal grains during annealing, and deteriorates magnetic properties. For this reason, the amount of N is set to 0.0100% or less. The amount of N is preferably 0.0050% or less and more preferably 0.0030% or less. Since the amount of N is preferably small, it is unnecessary to limit the lower limit value, and the lower limit value may be 0%. However, since it is not easy to make the content thereof 0% industrially, the lower limit value may be 0.0001% or more, greater than 0.0015%, or 0.0020% or more.

### Ti: 0% to 0.1000%

Titanium (T) is an element which is inevitably mixed in steel and can bind to carbon or nitrogen to form precipitates (carbides and nitrides). In a case where carbides or nitrides are formed, these precipitates themselves deteriorate magnetic properties of a non-oriented electrical steel sheet. Furthermore, carbides or nitrides inhibit growth of crystal grains during final annealing, whereby magnetic properties of a non-oriented electrical steel sheet deteriorate. Accordingly, the amount of Ti is set to 0.1000% or less. The amount of Ti is preferably 0.0100% or less, more preferably 0.0050% or less, and still more preferably 0.0020% or less. The amount of Ti may be 0%. A significant reduction in the amount of Ti may cause an increase in manufacturing costs, so the amount of Ti is preferably 0.0005% or more.

### Ca: 0% to 0.010%

Calcium (Ca) is a selective element which is effective for controlling inclusions because it suppresses precipitation of fine sulfides (such as MnS and Cu₂S) by forming coarse sulfides, and when it is incorporated moderately, it has an action of improving magnetic properties (for example, iron loss) by improving crystal grain growth properties. However, when it is excessively incorporated, the effect of the above-described action is saturated, leading to an increase in cost. Accordingly, the amount of Ca is set to 0.010% or less. The amount of Ca is preferably 0.008% or less and more preferably 0.005% or less. It is unnecessary to limit the lower limit value of Ca, and the lower limit value may be 0%. However, to more reliably obtain the effect of the above-described action, the amount of Ca is preferably set to 0.0003% or more. The amount of Ca is preferably 0.001% or more and more preferably 0.003% or more.

### Cr: 0% to 5.000%

Chromium (Cr) is a selective element that increases specific resistance and improves magnetic properties (for example, iron loss). However, when it is excessively incorporated, saturation magnetic flux density may be lowered and the effects of the above-described actions are saturated, leading to an increase in cost. Accordingly, the amount of Cr is set to 5.000% or less. The amount of Cr is preferably 0.500% or less and more preferably 0.100% or less. It is unnecessary to limit the lower limit value of Cr, and the lower limit value may be 0%. However, to more reliably obtain the effects of the above-described actions, the amount of Cr is preferably 0.0010% or more.

### Ni: 0% to 5.000%

Nickel (Ni) is a selective element that improves magnetic properties (for example, saturation magnetic flux density). However, when it is excessively incorporated, the effect of the above-described action is saturated, leading to an increase in cost. Accordingly, the amount of Ni is set to 5.000% or less. The amount of Ni is preferably 0.500% or less and more preferably 0.100% or less. It is unnecessary to limit the lower limit value of Ni, and the lower limit value may be 0%. However, to more reliably obtain the effect of the above-described action, the amount of Ni is preferably 0.0010% or more.

### Cu: 0% to 5.000%

Copper (Cu) is a selective element that improves steel sheet strength. However, when it is excessively incorporated, saturation magnetic flux density may be lowered and the effect of the above-described action is saturated, leading to an increase in cost. Accordingly, the amount of Cu is set to 5.000% or less. The amount of Cu is preferably 0.100% or less. It is unnecessary to limit the lower limit value of Cu, and the lower limit value may be 0%. However, to more reliably obtain the effects of the above-described actions, the amount of Cu is preferably 0.0010% or more.

### Sn: 0% to 0.100%

### Sb: 0% to 0.100%

Tin (Sn) and antimony (Sb) are selective elements having an action of improving magnetic properties (for example, magnetic flux density) by improving a texture of a non-oriented electrical steel sheet and may be incorporated as necessary. However, their excessive contents may embrittle steel and cause cold-rolling fracture, and may deteriorate magnetic properties. For this reason, the amount of Sn and the amount of Sb are each set to 0.100% or less. It is unnecessary to limit the lower limit values of Sn and Sb, and the lower limit values may be 0%. However, to more reliably obtain the effects of the above-described actions, the amount of Sn is preferably 0.001% or more and more preferably 0.010% or more. In addition, the amount of Sb is preferably 0.001% or more, preferably 0.002% or more, still more preferably 0.010% or more, and still more preferably greater than 0.025%.

### Ce: 0% to 0.100%

Cerium (Ce) is a selective element which suppresses precipitation of fine sulfides (such as MnS and Cu₂S) by forming coarse sulfides and oxysulfides and reduces iron loss by improving grain growth properties. However, when it is excessively incorporated, oxides may also be formed in addition to sulfides and oxysulfides, iron loss may deteriorate, and the effects of the above-described actions are saturated, leading to an increase in cost. Accordingly, the amount of Ce is set to 0.100% or less. The amount of Ce is preferably 0.010% or less, more preferably 0.009% or less, and still more preferably 0.008% or less. It is unnecessary to limit the lower limit value of Ce, and the lower limit value may be 0%. However, to more reliably obtain the effects of the above-described actions, the amount of Ce is preferably 0.001% or more. The amount of Ce is more preferably 0.002% or more, still more preferably 0.003% or more, and still more preferably 0.005% or more.

The chemical composition of the non-oriented electrical steel sheet according to the present embodiment may contain selective elements such as B, O, Mg, Ti, V, Zr, Nd, Bi, W, Mo, Nb, and Y in addition to the above-described elements. The amount of these selective elements may be controlled based on well-known findings. For example, the amount of these selective elements may be as follows.
V: 0% to 0.100%,
Zr: 0% to 0.100%,
Nb: 0% to 0.100%,
B: 0% to 0.100%,
O: 0% to 0.100%,
Mg: 0% to 0.100%,
Nd: 0% to 0.100%,
Bi: 0% to 0.100%,
W: 0% to 0.100%,
Mo: 0% to 0.100%, and
Y: 0% to 0.100%.

In addition, the non-oriented electrical steel sheet according to the present embodiment preferably has a chemical composition containing, by mass %, at least one of C: 0.0010% to 0.0050%, Sol. Al: 0.10% or more and less than 1.10%, Mn: 0.0010% to 1.10%, P: 0.0010% to 0.30%, S: 0.0001% to 0.0100%, N: greater than 0.0015% and 0.0100% or less, Ti: 0.0001% to 0.1000% V: 0.0001% to 0.100%, Zr: 0.0002% to 0.100%, Nb: 0.0001% to 0.100%, B: 0.0001% to 0.100%, O: 0.0001% to 0.100%, Mg: 0.0001% to 0.100%, Ca: 0.0003% to 0.010%, Cr: 0.0010% to 5.000%, Ni: 0.0010% to 5.000%, Cu: 0.0010% to 5.000%, Sn: 0.0010% to 0.100%, Sb: 0.0010% to 0.100%, Ce: 0.001% to 0.100%, Nd: 0.002% to 0.100%, Bi: 0.002% to 0.100%, W: 0.002% to 0.100%, Mo: 0.002% to 0.100%, and Y: 0.002% to 0.100%.

In addition, it is preferable that the amount of B be 0.01% or less, the amount of O be 0.01% or less, the amount of Mg be 0.005% or less, the amount of Ti be 0.002% or less, the amount of V be 0.002% or less, the amount of Zr be 0.002% or less, the amount of Nd be 0.01% or less, the amount of Bi be 0.01% or less, the amount of W be 0.01% or less, the amount of Nb be 0.002% or less, and the amount of Y be 0.01% or less. In addition, it is preferable that the amount of Ti be 0.001% or more, the amount of V be 0.002% or more, and the amount of Nb be 0.002% or more.

The above-described chemical component may be measured by a general analysis method for steel. For example, the chemical composition may be measured through Inductively Coupled Plasma-Atomic Emission Spectrometry (ICP-AES). The amount of Sol. Al may be measured through ICP-AES using a filtrate after thermally decomposing a sample with acid. In addition, the amount of Si may be measured through a silicon dioxide gravimetric method, the amounts of C and S may be measured through a combustion-infrared absorption method, the amount of N may be measured through an inert gas fusion-thermal conductivity method, and the amount of O may be measured through an inert gas fusion-nondispersive infrared absorption method.

The above-described chemical composition is that of a non-oriented electrical steel sheet that does not contain an insulation coating or the like. In a case where a non-oriented electrical steel sheet used as a measurement sample has an insulation coating or the like on its surface, the measurement is performed after removing this. For example, an insulation coating or the like may be removed through the following method. First, a non-oriented electrical steel sheet having an insulation coating or the like is immersed in a sodium hydroxide aqueous solution, a sulfuric acid aqueous solution, and a nitric acid aqueous solution, and then washed. Finally, it is dried with warm air. Accordingly, a non-oriented electrical steel sheet from which the insulation coating is removed can be obtained. In addition, the insulation coating or the like may be removed through grinding.

Furthermore, the non-oriented electrical steel sheet of the present embodiment may contain Sr, Ba, La, Pr, Zn, and Cd in addition to the above-described elements. Sr, Ba, La, Pr, Zn, and Cd coarsen sulfides that inhibit crystal grain growth and facilitate crystal grain growth, so they are appropriately incorporated as necessary.

Next, a suitable method for manufacturing the non-oriented electrical steel sheet of the present embodiment will be described.

A non-oriented electrical steel sheet can be obtained by performing, for example, steelmaking, hot rolling, hot-band annealing, pickling, cold rolling, and annealing on steel containing the above chemical components. For example, molten steel may be directly hot rolled through a rapid solidification method, or a hot-rolled sheet can also be obtained through thin slab casting and continuous hot rolling.

Hot-band annealing is a process in which a hot-rolled sheet in which a processed structure remains is heated to 800° C. to 1050° C. for recrystallization and grain growth. Accordingly, it is possible to produce a texture preferable for magnetic properties after subsequent cold rolling and annealing. In addition, in a component system that does not cause a-y transformation, hot-band annealing is performed not to cause surface unevenness called ridging in cold rolling, but hot-band annealing may not be performed in the present embodiment.

After pickling, a hot-rolled sheet (or hot-rolled and annealed sheet) is subjected to cold rolling to obtain a predetermined thickness. Cold rolling may be a one-time cold rolling method without intermediate annealing or may be a two-time cold rolling method with intermediate annealing or a multiple-time cold rolling method with multiple times of intermediate annealing. After cold rolling, annealing (final annealing) is performed to obtain a non-oriented electrical steel sheet. An insulation material may be applied to the surface of the non-oriented electrical steel sheet and baked to form an insulation coating.

In the process of manufacturing the non-oriented electrical steel sheet of the present embodiment, the following conditions are particularly satisfied to obtain a metal structure in which the average crystal grain size of the steel sheet before final cold rolling is 200 μm or less and the abundance ratio of crystal grains exceeding 200 μm is 10% or less of the total crystal grains.

To obtain the above-described metal structure before final cold rolling, for example, the average temperature increase rate in a temperature range of 700° C. or higher is set to 50° C./second or faster, the maximum sheet temperature reached (annealing temperature) is set to 1050° C. or lower, and the soaking time is set to 3 minutes or less in hot-band annealing in a case of a one-time cold rolling method in which hot-band annealing is carried out or in intermediate annealing before final cold rolling in the case of a two-time cold rolling method or a multiple-time cold rolling method. By carrying out annealing that satisfies these conditions, a metal structure in which the average crystal grain size before final cold rolling is 200 μm or less and the abundance ratio of crystal grains exceeding 200 μm is 10% or less of the total crystal grains can be obtained. That is, it is possible to obtain a steel sheet in which formation of a structure with uneven distribution of recrystallized structures and non-recrystallized structures which causes uneven distribution of residual stress is suppressed before final cold rolling. Preferably, the average temperature increase rate in a temperature range of 700° C. or higher is 60° C./second or faster. In addition, the maximum sheet temperature reached is preferably 1000° C. or lower. The soaking time is preferably 2 minutes or less and more preferably 1 minute or lower.

It is important not to cause non-uniform strain distribution in a steel sheet before carrying out hot-band annealing or before carrying out intermediate annealing before final cold rolling. For example, if a steel sheet is skin-pass rolled at a rolling reduction of 10% or smaller in a state in which it is recovered and recrystallized to some extent, only crystal grains having a specific orientation will undergo abnormal grain growth in the subsequent annealing, so-called strain-induced grain boundary migration occurs, and the abundance ratio of crystal grains exceeding 200 μm may account for 10% or more of the total crystal grains. Accordingly, not to cause non-uniform strain distribution in the steel sheet before carrying out annealing, it is important to set the rolling reduction of the previous rolling (hot rolling and cold rolling) to 15% or larger.

In addition, the annealing atmosphere in hot-band annealing or intermediate annealing before final cold rolling is set to be a dry nitrogen atmosphere. If the annealing atmosphere is set to a wet hydrogen atmosphere, a surface layer of the steel sheet is decarburized and the surface layer becomes a coarser structure than an inner layer. Since this coarse structure causes non-uniform strain distribution in the steel sheet, the annealing atmosphere in hot-band annealing or intermediate annealing before final cold rolling is preferably set to a dry nitrogen atmosphere.

The average crystal grain size before and after final cold rolling may be measured through a cutting method specified in JIS G0551:2020. For example, an average value of crystal grain sizes measured through the cutting method in the sheet thickness direction and the rolling direction in a vertical cross-sectional structure photograph may be used. An optical microscope photograph can be used as this vertical cross-sectional structure photograph, and for example, a photograph imaged at a magnification of 50 times may be used.

In addition, in the process of manufacturing the non-oriented electrical steel sheet of the present embodiment, the following conditions are particularly satisfied to set the abundance ratio of {100}<0vw>-oriented grains in the steel sheet before final cold rolling to 10% or less of the total crystal grains.

To obtain a metal structure in which the abundance ratio of the {100}<0vw>-oriented grains in the steel sheet before final cold rolling is 10% or less of the total crystal grains, if the composition system does not cause a-y transformation, it is effective to use electromagnetic stirring in continuous casting to prevent the growth of columnar crystals and promote the formation of equiaxed crystals. In addition, when a large number of specific oxides are present during solidification of molten steel, the formation of equiaxed crystals is promoted with precipitates serving as nuclei. On the other hand, when the degree of superheat of molten steel (temperature of molten steel−solidification temperature of molten steel) is high and the average cooling rate during solidification is high, columnar crystals tend to develop. For this reason, the formation of equiaxed grains is promoted by lowering the degree of superheat during casting and slowing down the average cooling rate.

Specifically, the degree of superheat is preferably set to 15° C. or lower, more preferably 10° C. or lower, and still more preferably 5° C. or lower. In addition, the average cooling rate at 900° C. in the cooling process is set to 20° C./second (72000° C./hr) or slower. The average cooling rate is desirably 10° C./second (36000° C./hr) or slower and is more desirably 5° C./second (18000° C./hr) or slower. In addition, when a slab and an ingot after casting are reheated before hot rolling, the heating temperature is set to 1100° C. or lower, and the heating time is set to 2 hours or shorter and desirably 1 hour or shorter.

The abundance ratio of the {100}<0vw>-oriented grains is measured as follows. The area proportion of each of the target-oriented grains is extracted (tolerance is set to 10°) from an observation field of view with a scanning electron microscope observed under the following measurement conditions using OIM Analysis Version 7.3.1 (manufactured by TSL). The extracted area is divided by the area of the observation field of view to obtain a percentage. This percentage is set to an area proportion of each oriented grain.

The detailed conditions of the method for measuring the abundance ratio of the {100}<0vw>-oriented grains are as follows.
Measurement device: Electron backscatter diffraction device-attached scanning electron microscope (SEM-EBSD)
SEM: “JSM-6400” (manufactured by JEOL)
EBSD detector: “HIKARI” (manufactured by TSL)
Step interval: 2 μm
Measurement target: Center layer (½ sheet thickness portion) of Z-plane (cut surface of steel sheet in sheet thickness direction) of steel sheet
Measurement region: 8000 μm×2400 μm region
Grain boundary: Angle difference in crystal orientation is 15° or more (continuous region with angle difference of less than 15° is regarded as one crystal grain)

Although the non-oriented electrical steel sheet according to the present embodiment has been described above, the sheet thickness of the non-oriented electrical steel sheet according to the present embodiment is preferably 0.35 mm or less. The sheet thickness thereof is more preferably 0.30 mm. On the other hand, excessive thinning significantly reduces the productivity of steel sheets and motors, so the sheet thickness is preferably 0.10 mm or more. The sheet thickness thereof is more preferably 0.15 mm or more.

In addition, the average crystal grain size of the non-oriented electrical steel sheet according to the present embodiment is 10 μm to 200 μm.

The sheet thickness may be measured with a micrometer. In a case where a non-oriented electrical steel sheet used as a measurement sample has an insulation coating or the like on its surface, the measurement is performed after removing this.

The present disclosure is not limited to the above-described embodiment. The above embodiment is an example, and any form which has substantially the same configuration as the technical idea described in the claims of the present disclosure and exhibits the same operational effects is included in the technical scope of the present disclosure.

### EXAMPLES

Hereinafter, the present disclosure will be specifically described with reference to examples. The conditions in the examples are examples employed for confirming the feasibility and effect of the present disclosure, and the present disclosure is not limited to these conditions of the examples. The present disclosure can adopt various conditions as long as the gist of the present disclosure is not deviated and the object of the present disclosure is achieved.

Underlines in Tables 1 to 3 indicate conditions outside the range of the present invention, unfavorable manufacturing conditions, or unfavorable roundness.

### Example 1

Regarding symbols 1F and 1G in Table 1, each steel containing, by mass %, Si: 3.00%, Sol. Al: 0.50%, Mn: 0.20%, C: 0.01%, and other unavoidable impurities was melted and finished to a sheet thickness of 2 mm through hot rolling. The hot-rolled sheet was heated to an annealing temperature (1,000° C. to 1,200° C.) at an average temperature increase rate shown in Table 1 and hot-band annealed for 2 minutes. The hot-rolled sheet was decarburized in a wet hydrogen atmosphere as an annealing atmosphere. A hot-rolled and annealed sheet which had a metal structure in Table 1 and a sheet thickness of 2 mm was obtained.

In addition, regarding symbols 1A to 1E and 1H to 1N in Table 1, each steel containing, by mass %, Si: 3.00%, Sol. Al: 0.50%, Mn: 0.20%, C: 0.0020%, and other unavoidable impurities was melted and finished to a sheet thickness of 2 mm through hot rolling. The hot-rolled sheet was heated to an annealing temperature (1,000° C. to 1,200° C.) at an average temperature increase rate shown in Table 1 and hot-band annealed for 2 minutes. The annealing atmosphere was set to a dry nitrogen atmosphere. A hot-rolled and annealed sheet which had a metal structure in Table 1 and a sheet thickness of 2 mm was obtained.

Next, the hot-rolled and annealed sheet was cold rolled to a sheet thickness of 0.25 mm, and subjected to annealing (final annealing) at 750° C. for 30 seconds to obtain each non-oriented electrical steel sheet. Cold rolling was performed by a one-time cold rolling method. “Base sheet manufacturing conditions” in Table 1 show the annealing temperature, the average temperature increase rate, and the annealing atmosphere of the hot-rolled and annealed sheet. In addition, the average crystal grain size of the base sheet before final cold rolling was measured and shown in Table 1.

A disk having a diameter of φ60 mm was punched out from each obtained non-oriented electrical steel sheet with a die and subjected to strain relief annealing (core annealing) at 750° C. for 2 hours, and the roundness was measured before and after the annealing. In addition, in the disk after the core annealing, D15_{MAX}/D2_{AVE}, DL/DC, and the area proportion (indicated by “*1” in Table 1) of crystal grains having a crystal grain size of less than 200 μm were obtained according to the above-described method.

The magnetic properties were evaluated as follows.

First, a 16×16 mm square sample for magnetic measurement was cut out from each obtained non-oriented electrical steel sheet. Subsequently, each cut-out sample was subjected to strain relief annealing (core annealing) for 750° C. for 2 hours, and iron loss W10/400 and magnetic flux density B50 were measured. In a case where the iron loss W10/400 is 14.0 W/kg or less and the magnetic flux density B50 is 1.65 T or more, the non-oriented electrical steel sheet had excellent magnetic properties and was determined to be acceptable. On the other hand, in a case where at least one of the iron loss W10/400 of 14.0 W/kg or more and the magnetic flux density B50 of 1.65 T or less was satisfied, the magnetic properties were evaluated as inferior and determined as unacceptable.

According to the evaluation criteria described above, the disks in which the ratio of the difference between the maximum value and the minimum value of the diameter of each disk to the average diameter is 0.200% or less are regarded as acceptable (invention example) and described in Table 1. In addition, the disks in which the ratio of the difference between the maximum value and the minimum value of the diameter to the average diameter exceeds 0.200% are regarded as unacceptable (comparative example) and described in Table 1.

In Table 1, 1A and 1B were unacceptable since the average crystal grain size of each steel sheet before final cold rolling was greater than 200 μm, the abundance ratio of crystal grains exceeding 200 μm was higher than 10%, and the roundness after strain relief annealing did not meet the evaluation criteria. It is thought that, in 1A and 1B, the average crystal grain size of each steel sheet before the final cold rolling exceeded 200 μm and the abundance ratio of crystal grains exceeding 200 μm was higher than 10% because the temperature reached by the hot-band annealing exceeded 1050° C. in both cases.

In 1C, although the abundance ratio of crystal grains exceeding 200 μm was 10%, 1C was unacceptable because the average crystal grain size of the steel sheet before final cold rolling was greater than 200 μm and the roundness after strain relief annealing did not meet the evaluation criteria. It is thought that, in 1C, the average crystal grain size of the steel sheet before the final cold rolling exceeded 200 μm because the temperature reached by the hot-band annealing exceeded 1050° C.

In 1F and 1G, although the average crystal grain size of each steel sheet before final cold rolling was 200 μm or less, 1F and 1G were unacceptable because the abundance ratio of crystal grains exceeding 200 μm was higher than 10% and the roundness after annealing did not meet the evaluation criteria. In 1F and 1G, although the temperature reached by the hot-band annealing was 1050° C., it is thought that the abundance ratio of crystal grains exceeding 200 μm was higher than 10% because the annealing was performed in a wet hydrogen atmosphere.

1I was unacceptable because the roundness after strain relief annealing did not meet the criteria. It is thought that, in 1I, the abundance ratio of crystal grains exceeding 200 μm was higher than 10% because the average temperature increase rate of the hot-band annealing was 45° C./second.

1D, 1E, 1H, and 1J to 1N were acceptable since the average crystal grain size of each steel sheet before final cold rolling was 200 μm or less, the abundance ratio of crystal grains exceeding 200 μm was 10% or less, and the roundness after annealing met the evaluation criteria.

As described above, it is determined that, by setting the temperature reached by hot-band annealing to 1050° C. or less and setting the hot-band annealing atmosphere to a dry nitrogen atmosphere, the average crystal grain size of each steel sheet before final cold rolling became 200 μm or less and the abundance ratio of crystal grains exceeding 200 μm became 10% or less of the total crystal grains, thereby obtaining desired roundness after punching. In addition, it is determined that all of 1D, 1E, 1H, and 1J to 1N which are the present invention examples provide low iron loss and sufficient magnetic flux density (favorable magnetic properties).

TABLE 1

| | | | | Base sheet | | | | |
|---|---|---|---|---|---|---|---|---|
| | | | | | Abundance | | | |
| | | | | Average | ratio of | | | |
| | Base shect manufacturing conditions | | | crystal | crystal | | | |
| | Annealing | Temperature | | grain | grains | Non-oriented electrical steel sheet | | |
| | temperature | increase rate | Annealing | size | exceeding | *1 | D15_{MAX}/ | |
| Symbol | (° C.) | (° C./second) | atmosphere | (μm) | 200 μm (%) | (%) | D2_{AVE} | DL/DC |
| 1A | 1200 | 51 | Dry | 250 | 30 | 15 | 10.0 | 5.5 |
| | | | nitrogen | | | | | |
| 1B | 1150 | 51 | Dry | 230 | 15 | 13 | 8.3 | 5.7 |
| | | | nitrogen | | | | | |
| 1C | 1100 | 54 | Dry | 210 | 10 | 12 | 7.1 | 6.2 |
| | | | nitrogen | | | | | |
| 1D | 1050 | 51 | Dry | 190 | 8 | 9 | 4.2 | 4.5 |
| | | | nitrogen | | | | | |
| 1E | 1000 | 54 | Dry | 160 | 7 | 5 | 1.1 | 2.0 |
| | | | nitrogen | | | | | |
| 1F | 1050 | 51 | Wet | 190 | 15 | 14 | 9.2 | 5.3 |
| | | | hydrogen | | | | | |
| 1G | 1050 | 51 | Wet | 185 | 12 | 11 | 5.5 | 6.6 |
| | | | hydrogen | | | | | |
| 1H | 1050 | 51 | Dry | 190 | 5 | 7 | 2.5 | 3.8 |
| | | | nitrogen | | | | | |
| 1I | 1050 | 45 | Dry | 190 | 12 | 11 | 5.2 | 5.7 |
| | | | nitrogen | | | | | |
| 1J | 1000 | 63 | Dry | 140 | 5 | 3 | 1.1 | 1.8 |
| | | | nitrogen | | | | | |
| 1K | 1000 | 70 | Dry | 130 | 4 | 2 | 1.1 | 1.6 |
| | | | nitrogen | | | | | |
| 1L | 1000 | 54 | Dry | 8 | 0 | 9 | 4.8 | 4.7 |
| | | | nitrogen | | | | | |
| 1M | 1050 | 57 | Dry | 170 | 9 | 6 | 5.5 | 4.5 |
| | | | nitrogen | | | | | |
| 1N | 1000 | 51 | Dry | 180 | 8 | 7 | 4.5 | 5.5 |
| | | | nitrogen | | | | | |
| | | | Non-oriented electrical steel sheet | | | | | |
| | | | Roundness | Roundness | Magnetic | W10/400 | B50 after | |
| | | | before core | after core | properties | after core | core | |
| | | | annealing | annealing | after core | annealing | annealing | |
| | | Symbol | (%) | (%) | annealing | (W/kg) | (T) | Remark |
| | | 1A | 0.100% | 0.250% | Favorable | 13.1 | 1.67 | Comparative |
| | | | | | | | | example |
| | | 1B | 0.100% | 0.250% | Favorable | 13.2 | 1.67 | Comparative |
| | | | | | | | | example |
| | | 1C | 0.100% | 0.225% | Favorable | 13.0 | 1.67 | Comparative |
| | | | | | | | | example |
| | | 1D | 0.075% | 0.100% | Favorable | 13.3 | 1.67 | Invention |
| | | | | | | | | example |
| | | 1E | 0.050% | 0.075% | Favorable | 12.9 | 1.66 | Invention |
| | | | | | | | | example |
| | | 1F | 0.075% | 0.225% | Favorable | 13.2 | 1.67 | Comparative |
| | | | | | | | | example |
| | | 1G | 0.075% | 0.225% | Favorable | 13.1 | 1.66 | Comparative |
| | | | | | | | | example |
| | | 1H | 0.050% | 0.075% | Favorable | 13.2 | 1.67 | Invention |
| | | | | | | | | example |
| | | 1I | 0.050% | 0.225% | Favorable | 13.2 | 1.66 | Comparative |
| | | | | | | | | example |
| | | 1J | 0.050% | 0.050% | Favorable | 12.9 | 1.67 | Invention |
| | | | | | | | | example |
| | | 1K | 0.025% | 0.025% | Favorable | 12.8 | 1.67 | Invention |
| | | | | | | | | example |
| | | 1L | 0.025% | 0.125% | Favorable | 13.1 | 1.65 | Invention |
| | | | | | | | | example |
| | | 1M | 0.075% | 0.100% | Favorable | 13.1 | 1.65 | Invention |
| | | | | | | | | example |
| | | 1N | 0.075% | 0.100% | Favorable | 13.0 | 1.65 | Invention |
| | | | | | | | | example |

*1: area proportion of crystal grains having crystal grain size of less than 200 μm when boundary with crystal orientation difference of 2° or more and less than 15° is regarded as crystal grain boundary,

### Example 2

Each steel containing, by mass %, Si: 3.00%, Sol. Al: 0.50%, Mn: 0.20%, C: 0.0020%, and other unavoidable impurities was melted, and the deoxidation time was adjusted to change the amount of oxygen in the molten steel. The molten steel was poured into a template, and each ingot was manufactured by changing the degree of superheat of the molten steel and the average cooling rate at 900° C. or higher as shown in Table 2. The average cooling rate is as shown in Table 2. After the ingot was heated at 1,100° C. to 1,200° C. for 1 to 5 hours, it was hot rolled and finished to a sheet thickness of 1.8 mm. The hot-rolled sheet was hot-band annealed at 1,050° C. for 2 minutes in a dry nitrogen atmosphere to obtain a hot-rolled sheet which had the metal structure in Table 2 and a sheet thickness of 1.8 mm.

Next, the hot-rolled and annealed sheet was cold rolled to a sheet thickness of 0.20 mm, and subjected to annealing (final annealing) at 750° C. for 30 seconds to obtain each non-oriented electrical steel sheet. Cold rolling was performed by a one-time cold rolling method.

A disk having a diameter of φ60 mm was punched out from each obtained non-oriented electrical steel sheet with a die and subjected to strain relief annealing (core annealing) at 750° C. for 2 hours, and the roundness was measured before and after the annealing.

In addition, in the disk after the core annealing, D15_{MAX}/D2_{AVE}, DL/DC, and the area proportion (indicated by “*1” in Table 2) of crystal grains having a crystal grain size of less than 200 μm were obtained in the same manner as in (Example 1). Furthermore, the magnetic properties of the disk obtained after the core annealing were also determined in the same manner.

According to the evaluation criteria described above, the disks in which the ratio of the difference between the maximum value and the minimum value of the diameter to the average diameter is 0.200% or less are regarded as acceptable (invention example) and described in Table 2. In addition, the disks in which the ratio of the difference between the maximum value and the minimum value of the diameter to the average diameter exceeds 0.200% are regarded as unacceptable (comparative example) and described in Table 2.

2A, 2B, 2F, and 2G in Table 2 were unacceptable since the abundance ratio of {100}<0vw>-oriented grains was higher than 10% and the roundness after strain relief annealing did not meet the evaluation criteria.

It is thought that, in 2A, the abundance ratio of {100}<0vw>-oriented grains became higher than 10% because the heating temperature of the ingot before hot rolling was higher than 1100° C. and the heating time was longer than 2 hours.

In addition, in 2B and 2F, although the heating time of each ingot was 2 hours, it is thought that the abundance ratio of {100}<0vw>-oriented grains became higher than 10% because the heating time was higher than 1100° C.

In addition, in 2G, although the heating time of the ingot was 1100° C. and the heating time was 1 hour, it is thought that the abundance ratio of {100}<0vw>-oriented grains became higher than 10% because the cooling rate during solidification was relatively high (200,000° C./hr).

2C, 2D, 2E, 2H, and 2K to 2N were acceptable since the abundance ratio of {100}<0vw>-oriented grains was 10% or lower and the roundness after annealing did not meet the evaluation criteria. As described above, it is determined that, by setting the heating temperature of each ingot to 1100° C. or lower, the heating time to 1 hour or shorter, and the cooling rate to 20° C./second (72000° C./hr) or slower, the abundance ratio of {100}<0vw>-oriented grains in each steel sheet before final cold rolling became 10% or less of the total crystal grains, thereby obtaining desired roundness after punching.

TABLE 2

| | Base sheet manufacturing conditions | | | | Base sheet | | | |
|---|---|---|---|---|---|---|---|---|
| | | | | | Average | Abundance | | |
| | | Average | Ingot heating | | crystal | ratio of | Non-oriented electrical | |
| | degree of | cooling | Heating | Heating | grain | {100}<0vw>- | steel sheet | |
| | superheat | rate | temperature | time | size | oriented | *1 | D15_{MAX}/ |
| Symbol | (° C.) | (° C./hr) | (° C.) | (hour) | (μm) | grains | (%) | D2_{AVE} |
| 2A | 14 | 200,000 | 1200 | 5 | 190 | 30 | 17 | 7.3 |
| 2E | 14 | 100 | 1200 | 2 | 180 | 15 | 12 | 5.8 |
| 2C | 13 | 72,000 | 1100 | 1 | 185 | 10 | 9 | 4.7 |
| 2D | 13 | 100 | 1100 | 1 | 190 | 8 | 8 | 3.5 |
| 2E | 14 | 100 | 1100 | 1 | 160 | 7 | 5 | 2.3 |
| 2F | 13 | 200,000 | 1200 | 2 | 190 | 15 | 13 | 6.5 |
| 2G | 12 | 200,000 | 1100 | 1 | 185 | 12 | 11 | 5.7 |
| 2H | 14 | 100 | 1100 | 1 | 190 | 5 | 6 | 1.2 |
| 2I | 20 | 200,000 | 1100 | 1 | 185 | 32 | 18 | 12.0 |
| 2K | 9 | 100 | 1100 | 1 | 190 | 6 | 6 | 3.0 |
| 2L | 3 | 100 | 1100 | 1 | 190 | 3 | 5 | 2.5 |
| 2M | 14 | 100 | 1100 | 1 | 160 | 7 | 7 | 5.5 |
| 2N | 14 | 100 | 1100 | 1 | 160 | 7 | 9 | 4.5 |
| | | Non-oriented electrical steel sheet | | | | | | |
| | | | Roundness | Roundness | Magnetic | W10/400 | B50 after | |
| | | | before core | after core | properties | after core | core | |
| | | | annealing | annealing | after core | annealing | annealing | |
| | Symbol | DI/DC | (%) | (%) | annealing | (W/kg) | (T) | Remark |
| | 2A | 5.7 | 0.100% | 0.250% | Favorable | 13.2 | 1.67 | Comparative |
| | | | | | | | | example |
| | 2E | 5.3 | 0.100% | 0.225% | Favorable | 12.9 | 1.66 | Comparative |
| | | | | | | | | example |
| | 2C | 4.3 | 0.075% | 0.100% | Favorable | 12.9 | 1.67 | Invention |
| | | | | | | | | example |
| | 2D | 3.5 | 0.075% | 0.075% | Favorable | 13.1 | 1.66 | Invention |
| | | | | | | | | example |
| | 2E | 2.3 | 0.050% | 0.050% | Favorable | 13.0 | 1.66 | Invention |
| | | | | | | | | example |
| | 2F | 5.6 | 0.100% | 0.225% | Favorable | 13.1 | 1.67 | Comparative |
| | | | | | | | | example |
| | 2G | 5.5 | 0.075% | 0.225% | Favorable | 12.9 | 1.66 | Comparative |
| | | | | | | | | example |
| | 2H | 2.1 | 0.050% | 0.075% | Favorable | 13.2 | 1.66 | Invention |
| | | | | | | | | example |
| | 2I | 7.0 | 0.100% | 0.250% | Favorable | 13.1 | 1.69 | Comparative |
| | | | | | | | | example |
| | 2K | 3.5 | 0.050% | 0.050% | Favorable | 13.1 | 1.66 | Invention |
| | | | | | | | | example |
| | 2L | 2.5 | 0.050% | 0.050% | Favorable | 13.2 | 1.65 | Invention |
| | | | | | | | | example |
| | 2M | 4.5 | 0.075% | 0.100% | Favorable | 13.2 | 1.67 | Invention |
| | | | | | | | | example |
| | 2N | 5.5 | 0.100% | 0.100% | Favorable | 13.1 | 1.66 | Invention |
| | | | | | | | | example |

*1: area proportion of crystal grains having crystal grain size of less than 200 μm when boundary with crystal orientation difference of 2° or more and less than 15° is regarded as crystal grain boundary,

### Example 3

Regarding symbols 1F and 1G in Table 3, each steel containing, by mass %, Si: 3.00%, Sol. Al: 0.50%, Mn: 0.20%, C: 0.01%, and other unavoidable impurities was melted and finished to a sheet thickness of 2 mm through hot rolling. The hot-rolled sheet was heated to an annealing temperature (1,000° C. to 1,200° C.) at an average temperature increase rate shown in Table 1 and hot-band annealed for 2 minutes. The hot-rolled sheet was decarburized in a wet hydrogen atmosphere as an annealing atmosphere. A hot-rolled and annealed sheet which had a metal structure in Table 3 and a sheet thickness of 2 mm was obtained.

In addition, regarding symbols 1A to 1E and 1H to 1N in Table 3, each steel containing, by mass %, Si: 3.00%, Sol. Al: 0.50%, Mn: 0.20%, C: 0.0020%, and other unavoidable impurities was melted and finished to a sheet thickness of 2 mm through hot rolling. The hot-rolled sheet was heated to an annealing temperature (1,000° C. to 1,200° C.) at an average temperature increase rate shown in Table 1 and hot-band annealed for 2 minutes. The annealing atmosphere was set to a dry nitrogen atmosphere. A hot-rolled and annealed sheet which had a metal structure in Table 3 and a sheet thickness of 2 mm was obtained.

Next, the hot-rolled and annealed sheet was cold rolled to a sheet thickness of 0.25 mm and subjected to annealing (final annealing) at 750° C. for 30 seconds to obtain a non-oriented electrical steel sheet. Cold rolling was performed by a one-time cold rolling method. “Base sheet manufacturing conditions” in Table 3 show the annealing temperature, the average temperature increase rate, and the annealing atmosphere of the hot-rolled and annealed sheet. In addition, the average crystal grain size of the base sheet before final cold rolling was measured and shown in Table 3.

A disk having a diameter of φ60 mm was punched out from each obtained non-oriented electrical steel sheet with a die and subjected to strain relief annealing (core annealing) at 750° C. for 2 hours, and the roundness was measured before and after the strain relief annealing.

In addition, in the disk after the core annealing, D15_{MAX}/D2_{AVE}, DL/DC, and the area proportion (indicated by “*1” in Table 3) of crystal grains having a crystal grain size of less than 200 μm were obtained in the same manner as in (Example 1). Furthermore, the magnetic properties of the disk obtained after the core annealing were also determined in the same manner.

According to the evaluation criteria described above, the disks in which the ratio of the difference between the maximum value and the minimum value of the diameter to the average diameter is 0.200% or less are regarded as acceptable (invention example) and described in Table 3. In addition, the disks in which the ratio of the difference between the maximum value and the minimum value of the diameter to the average diameter exceeds 0.200% are regarded as unacceptable (comparative example) and described in Table 3.

In Table 3, 3A to 3H met the evaluation criteria for the roundness before strain relief annealing. However, although 3J did not meet the evaluation criteria for the roundness before strain relief annealing, it was acceptable because the average crystal grain size of the steel sheet before final cold rolling was 200 μm or less, the abundance ratio of crystal grains exceeding 200 μm was 10% or less, and the roundness after annealing met the evaluation criteria.

3A and 3B were unacceptable since the average crystal grain size of each steel sheet before final cold rolling was greater than 200 μm, the abundance ratio of crystal grains exceeding 200 μm was higher than 10%, and the roundness after strain relief annealing did not meet the evaluation criteria. It is thought that, in 3A and 3B, the average crystal grain size of each steel sheet before the final cold rolling exceeded 200 μm and the abundance ratio of crystal grains exceeding 200 μm was higher than 10% because the temperature reached by the hot-band annealing exceeded 1050° C. in both cases. In 3C, although the abundance ratio of crystal grains exceeding 200 μm was 10%, 3C was unacceptable because the average crystal grain size of the steel sheet before final cold rolling was greater than 200 μm and the roundness after strain relief annealing did not meet the evaluation criteria.

It is thought that, in 3C, the average crystal grain size of the steel sheet before the final cold rolling exceeded 200 μm because the temperature reached by the hot-band annealing exceeded 1050° C. In 3F and 3G, although the average crystal grain size of each steel sheet before final cold rolling was 200 μm or less, 3F and 3G were unacceptable because the abundance ratio of crystal grains exceeding 200 μm was higher than 10% and the roundness after annealing did not meet the evaluation criteria.

In 3F and 3G, although the temperature reached by the hot-band annealing was 1050° C., it is thought that the abundance ratio of crystal grains exceeding 200 μm was higher than 10% because the annealing was performed in a wet hydrogen atmosphere.

3D, 3E, and 3H were acceptable since the average crystal grain size of each steel sheet before final cold rolling was 200 μm or less, the abundance ratio of crystal grains exceeding 200 μm was 10% or less, and the roundness after annealing met the evaluation criteria.

As described above, it is determined that, by setting the temperature reached by hot-band annealing to 1050° C. or less and setting the hot-band annealing atmosphere to a dry nitrogen atmosphere, the average crystal grain size of each steel sheet before final cold rolling became 200 μm or less and the abundance ratio of crystal grains exceeding 200 μm became 10% or less of the total crystal grains, thereby obtaining desired roundness after punching.

Although 3J did not meet the evaluation criteria for the roundness before strain relief annealing, it was acceptable because the average crystal grain size of the steel sheet before final cold rolling was 200 μm or less, the abundance ratio of crystal grains exceeding 200 μm was 10% or less, and the roundness after strain relief annealing met the evaluation criteria.

As described above, invention examples in which both the roundness before strain relief annealing and the roundness after strain relief annealing meet the evaluation criteria and invention examples in which the roundness before strain relief annealing does not meet the evaluation criteria but the roundness after strain relief annealing meets the evaluation criteria are included. Furthermore, invention examples in which the roundness before strain relief annealing meets the evaluation criteria are also included, including those such as rotor cores that are not subjected to strain relief annealing. Accordingly, in the invention examples, at least any of the roundness before strain relief annealing and the roundness after strain relief annealing meets the evaluation criteria.

TABLE 3

| | | | | Base sheet | | | | |
|---|---|---|---|---|---|---|---|---|
| | | | | | Abundance | | | |
| | Base sheet manufacturing conditions | | | Average | ratio of | | | |
| | | Average | | crystal | crystal | Non-oriented | | |
| | Annealing | temperature | | grain | grains | electrical steel sheet | | |
| | temperature | increase rate | Anncaling | size | exceeding | *1 | D15_{MAX}/ | |
| Symbol | (° C.) | (° C./second) | atmosphere | (μm) | 200 μm (%) | (%) | D2_{AVE} | DL/DC |
| 3A | 1200 | 51 | Dry | 250 | 30 | 15 | 10.0 | 5.5 |
| | | | nitrogen | | | | | |
| 3B | 1150 | 51 | Dry | 230 | 15 | 13 | 8.3 | 5.7 |
| | | | nitrogen | | | | | |
| 3C | 1100 | 54 | Dry | 210 | 10 | 12 | 7.1 | 6.2 |
| | | | nitrogen | | | | | |
| 3D | 1050 | 51 | Dry | 190 | 8 | 9 | 4.2 | 4.5 |
| | | | nitrogen | | | | | |
| 3E | 1000 | 54 | Dry | 160 | 7 | 5 | 1.1 | 2.0 |
| | | | nitrogen | | | | | |
| 3I | 1050 | 51 | Wet | 190 | 15 | 14 | 9.2 | 5.3 |
| | | | hydrogen | | | | | |
| 3G | 1050 | 51 | Wet | 185 | 12 | 11 | 5.5 | 6.6 |
| | | | hydrogen | | | | | |
| 3H | 1050 | 51 | Dry | 190 | 5 | 7 | 2.5 | 3.8 |
| | | | nitrogen | | | | | |
| 3J | 1050 | 54 | Dry | 200 | 10 | 9 | 4.5 | 4.7 |
| | | | nitrogen | | | | | |
| 3K | 1000 | 54 | Dry | 160 | 7 | 9 | 5.5 | 4.5 |
| | | | nitrogen | | | | | |
| 3L | 1000 | 54 | Dry | 160 | 7 | 7 | 4.5 | 5.5 |
| | | | nitrogen | | | | | |
| | | | Non-oriented electrical steel sheet | | | | | |
| | | | Roundness | Roundness | Magnetic | W10/400 | B50 after | |
| | | | before core | after core | properties | after core | core | |
| | | | annealing | annealing | after core | annealing | annealing | |
| | | Symbol | (%) | (%) | annealing | (W/kg) | (T) | Remark |
| | | 3A | 0.100% | 0.250% | Favorable | 13.0 | 1.67 | Comparative |
| | | | | | | | | example |
| | | 3B | 0.100% | 0.250% | Favorable | 13.2 | 1.67 | Comparative |
| | | | | | | | | example |
| | | 3C | 0.100% | 0.225% | Favorable | 13.0 | 1.67 | Comparative |
| | | | | | | | | example |
| | | 3D | 0.075% | 0.100% | Favorable | 13.3 | 1.67 | Invention |
| | | | | | | | | example |
| | | 3E | 0.050% | 0.050% | Favorable | 12.9 | 1.66 | Invention |
| | | | | | | | | example |
| | | 3I | 0.075% | 0.225% | Favorable | 13.2 | 1.67 | Comparative |
| | | | | | | | | example |
| | | 3G | 0.075% | 0.225% | Favorable | 13.1 | 1.66 | Comparative |
| | | | | | | | | example |
| | | 3H | 0.050% | 0.075% | Favorable | 13.2 | 1.67 | Invention |
| | | | | | | | | example |
| | | 3J | 0.125% | 0.100% | Favorable | 12.9 | 1.67 | Invention |
| | | | | | | | | example |
| | | 3K | 0.075% | 0.100% | Favorable | 13.1 | 1.67 | Invention |
| | | | | | | | | example |
| | | 3L | 0.100% | 0.100% | Favorable | 13.2 | 1.66 | Invention |
| | | | | | | | | example |

*1: area proportion of crystal grains having crystal grain size of less than 200 μm when boundary with crystal orientation difference of 2° or more and less than 15° is regarded as crystal grain boundary,

### Example 4

Each steel containing, by mass %, components shown in Tables 4A and 4B and other unavoidable impurities was melted and finished to a sheet thickness of 2 mm through hot rolling. The hot-rolled sheet was subjected to hot-band annealing at 1,050° C. for 2 minutes. The annealing atmosphere was set to a dry nitrogen atmosphere to obtain a hot-rolled sheet which had the metal structure in Tables 4A and 4B and a sheet thickness of 2 mm.

Next, the hot-rolled and annealed sheet was cold rolled to a sheet thickness of 0.25 mm and subjected to annealing (final annealing) at 750° C. for 30 seconds to obtain a non-oriented electrical steel sheet. Cold rolling was performed by a one-time cold rolling method. In addition, the average crystal grain size of the base sheet before final cold rolling and the abundance ratio of the crystal grains exceeding 200 μm were measured and shown in Table 5.

A disk having a diameter of φ60 mm was punched out from each obtained non-oriented electrical steel sheet with a die and subjected to strain relief annealing (core annealing) at 750° C. for 2 hours, and the roundness was measured before and after the strain relief annealing.

In addition, in the disk after the core annealing, D15_{MAX}/D2_{AVE}, DL/DC, and the area proportion (indicated by “*1” in Table 5) of crystal grains having a crystal grain size of less than 200 μm were obtained according to the above-described method.

According to the evaluation criteria described above, the disks in which the ratio of the difference between the maximum value and the minimum value of the diameter to the average diameter is 0.200% or less are regarded as acceptable (invention example) and described in Table 5.

A 16×16 mm square sample for magnetic measurement was cut out from each obtained non-oriented electrical steel sheet and subjected to strain relief annealing (core annealing) at 750° C. for 2 hours, and the iron loss W10/400 and the magnetic flux density B50 were measured. In a case where the iron loss W10/400 is 14.00 W/kg or less and the magnetic flux density B50 is 1.650 T or more, the non-oriented electrical steel sheet had excellent magnetic properties and was determined to be acceptable.

In Table 5, all of 4A1 to 4S were acceptable since the average crystal grain size of each steel sheet before final cold rolling was 200 μm or less, the abundance ratio of crystal grains exceeding 200 μm was 10% or less, and the roundness after core annealing met the evaluation criteria. In addition, it is determined that all of 4A1 to 4S which are the present invention examples provide low iron loss and sufficient magnetic flux density (favorable magnetic properties).

As described above, according to the present invention, it is determined that the average crystal grain size of each steel sheet before final cold rolling becomes 200 μm or less and the abundance ratio of the crystal grains exceeding 200 μm becomes 10% or less of the total crystal grains, enabling both favorable roundness and favorable magnetic properties after punching and core annealing.

TABLE 4A

| | Chemical composition (mass %, balance: Fe and impurities) | | | | | | | | | | | | |
|---|---|---|---|---|---|---|---|---|---|---|---|---|---|
| Symbol | C | Si | sol. Al | Mn | P | S | N | Ti | V | Zr | Nb | B | O |
| 4A1 | 0.0020 | 2.05 | 0.50 | 0.20 | 0.01 | 0.0010 | 0.0020 | 0.0010 | — | — | — | — | 0.002 |
| 4A2 | 0.0020 | 2.50 | 0.50 | 0.20 | 0.01 | 0.0010 | 0.0020 | 0.0010 | — | — | — | — | 0.002 |
| 4A3 | 0.0020 | 3.05 | 0.50 | 0.20 | 0.01 | 0.0010 | 0.0020 | 0.0010 | — | — | — | — | 0.002 |
| 4A4 | 0.0020 | 3.10 | 0.50 | 0.20 | 0.01 | 0.0010 | 0.0020 | 0.0010 | — | — | — | — | 0.002 |
| 4A5 | 0.0020 | 3.20 | 0.50 | 0.20 | 0.01 | 0.0010 | 0.0020 | 0.0010 | — | — | — | — | 0.002 |
| 4B | 0.0020 | 3.00 | 1.05 | 0.20 | 0.01 | 0.0010 | 0.0020 | 0.0010 | — | — | — | — | 0.002 |
| 4C | 0.0020 | 3.00 | 0.50 | 0.20 | 0.01 | 0.0010 | 0.0020 | 0.0010 | — | — | — | 0.095 | 0.002 |
| 4D | 0.0020 | 3.00 | 0.50 | 0.20 | 0.01 | 0.0010 | 0.0020 | 0.0010 | — | — | — | — | 0.002 |
| 4E1 | 0.0020 | 3.00 | 0.50 | 0.20 | 0.01 | 0.0010 | 0.0020 | 0.0010 | — | — | — | — | 0.002 |
| 4E2 | 0.0020 | 3.00 | 0.50 | 0.20 | 0.01 | 0.0010 | 0.0020 | 0.0010 | — | — | — | — | 0.002 |
| 4F | 0.0020 | 3.00 | 0.50 | 0.20 | 0.01 | 0.0010 | 0.0020 | 0.0010 | 0.092 | — | — | — | 0.002 |
| 4G | 0.0020 | 3.00 | 0.50 | 0.20 | 0.01 | 0.0010 | 0.0020 | 0.0010 | — | — | — | — | 0.002 |
| 4H | 0.0020 | 3.00 | 0.50 | 0.20 | 0.01 | 0.0010 | 0.0020 | 0.0010 | — | — | — | — | 0.002 |
| 4I | 0.0020 | 3.00 | 0.50 | 0.20 | 0.01 | 0.0010 | 0.0020 | 0.0010 | — | — | — | — | 0.002 |
| 4J | 0.0020 | 3.00 | 0.50 | 0.20 | 0.01 | 0.0010 | 0.0020 | 0.0010 | — | 0.093 | — | — | 0.002 |
| 4K | 0.0020 | 3.00 | 0.50 | 0.20 | 0.01 | 0.0010 | 0.0020 | 0.0010 | — | — | — | — | 0.002 |
| 4L | 0.0020 | 3.00 | 0.50 | 0.20 | 0.01 | 0.0010 | 0.0020 | 0.0010 | — | — | — | — | 0.002 |
| 4M | 0.0020 | 3.00 | 0.50 | 0.20 | 0.01 | 0.0010 | 0.0020 | 0.0010 | — | — | — | — | 0.002 |
| 4N | 0.0020 | 3.00 | 0.50 | 0.20 | 0.01 | 0.0010 | 0.0020 | 0.0010 | — | — | — | — | 0.002 |
| 4O | 0.0020 | 3.00 | 0.50 | 0.20 | 0.01 | 0.0010 | 0.0020 | 0.0010 | — | — | — | — | 0.002 |
| 4P | 0.0020 | 3.00 | 0.50 | 0.20 | 0.01 | 0.0010 | 0.0020 | 0.0010 | — | — | — | — | 0.002 |
| 4Q | 0.0020 | 3.00 | 0.50 | 0.20 | 0.01 | 0.0010 | 0.0020 | 0.0010 | — | — | — | — | 0.002 |
| 4R | 0.0020 | 3.00 | 0.50 | 0.20 | 0.01 | 0.0010 | 0.0020 | 0.0010 | — | — | 0.091 | — | 0.002 |
| 4S | 0.0020 | 3.00 | 0.50 | 0.20 | 0.01 | 0.0010 | 0.0020 | 0.0010 | — | — | — | — | 0.002 |

TABLE 4B
Chemical composition (mass %, balance: Fe and impurities)

| Symbol | Mg | Ca | Cr | Ni | Cu | Sn | Sb | Ce | Nd | Bi | W | Mo | Y |
|---|---|---|---|---|---|---|---|---|---|---|---|---|---|
| 4A1 | — | — | — | — | — | — | — | — | — | — | — | — | — |
| 4A2 | — | — | — | — | — | — | — | — | — | — | — | — | — |
| 4A3 | — | — | — | — | — | — | — | — | — | — | — | — | — |
| 4A4 | — | — | — | — | — | — | — | — | — | — | — | — | — |
| 4A5 | — | — | — | — | — | — | — | — | — | — | — | — | — |
| 4B | — | — | — | — | — | — | — | — | — | — | — | — | — |
| 4C | — | — | — | — | — | — | — | — | — | — | — | — | — |
| 4D | 0.090 | — | — | — | — | — | — | — | — | — | — | — | — |
| 4E1 | — | — | — | — | — | — | — | — | — | — | — | — | — |
| 4E2 | — | 0.099 | — | — | — | — | — | — | — | — | — | — | — |
| 4F | — | — | — | — | — | — | — | — | — | — | — | — | — |
| 4G | — | — | 4.870 | — | — | — | — | — | — | — | — | — | — |
| 4H | — | — | — | 4.250 | — | — | — | — | — | — | — | — | — |
| 4I | — | — | — | — | 4.550 | — | — | — | — | — | — | — | — |
| 4J | — | — | — | — | — | — | — | — | — | — | — | — | — |
| 4K | — | — | — | — | — | 0.095 | — | — | — | — | — | — | — |
| 4L | — | — | — | — | — | — | 0.098 | — | — | — | — | — | — |
| 4M | — | — | — | — | — | — | — | 0.099 | — | — | — | — | — |
| 4N | — | — | — | — | — | — | — | — | 0.093 | — | — | — | — |
| 4O | — | — | — | — | — | — | — | — | — | 0.091 | — | — | — |
| 4P | — | — | — | — | — | — | — | — | — | — | 0.094 | — | — |
| 4Q | — | — | — | — | — | — | — | — | — | — | — | 0.095 | — |
| 4R | — | — | — | — | — | — | — | — | — | — | — | — | — |
| 4S | — | — | — | — | — | — | — | — | — | — | — | — | 0.099 |

TABLE 5

| | Base sheet | | | | | | | | | | |
|---|---|---|---|---|---|---|---|---|---|---|---|
| | | Abundance | | | | | | | | | |
| | | ratio of | Electrical steel sheet | | | | | | | | |
| | Avcrage | crystal | | | | Roundness | Roundness | Average | | | |
| | crystal | grains | | | | before | after | crystal | | | |
| | grain | cxceeding | | | | core | core | grain | W10/ | | |
| | size | 200 μm | *1 | D15_{MAX}/ | | annealing | annealing | size | 400 | B50 | |
| Symbol | (μm) | (%) | (%) | D2_{AVE} | DL/DC | (%) | (%) | (μm) | (W/kg) | (T) | Remark |
| 4A1 | 195 | 8 | 5 | 1.6 | 1.8 | 0.110% | 0.125% | 100 | 13.69 | 1.709 | Invention |
| | | | | | | | | | | | example |
| 4A2 | 190 | 6 | 5 | 1.2 | 1.8 | 0.090% | 0.100% | 100 | 12.77 | 1.693 | Invention |
| | | | | | | | | | | | example |
| 4A3 | 190 | 5 | 4 | 1.0 | 1.4 | 0.070% | 0.080% | 100 | 11.90 | 1.674 | Invention |
| | | | | | | | | | | | example |
| 4A4 | 185 | 3 | 4 | 0.6 | 1.4 | 0.100% | 0.065% | 100 | 11.83 | 1.672 | Invention |
| | | | | | | | | | | | example |
| 4A5 | 180 | 2 | 3 | 0.4 | 1.1 | 0.070% | 0.050% | 100 | 11.70 | 1.669 | Invention |
| | | | | | | | | | | | example |
| 4B | 180 | 6 | 5 | 1.2 | 1.8 | 0.105% | 0.100% | 100 | 11.40 | 1.650 | Invention |
| | | | | | | | | | | | example |
| 4C | 150 | 8 | 7 | 1.6 | 2.5 | 0.075% | 0.160% | 70 | 13.98 | 1.664 | Invention |
| | | | | | | | | | | | example |
| 4D | 185 | 6 | 5 | 1.2 | 1.8 | 0.110% | 0.100% | 100 | 13.88 | 1.668 | Invention |
| | | | | | | | | | | | example |
| 4E1 | 190 | 5 | 5 | 1.0 | 1.8 | 0.125% | 0.090% | 100 | 11.97 | 1.676 | Invention |
| | | | | | | | | | | | example |
| 4E2 | 185 | 4 | 5 | 0.8 | 1.8 | 0.115% | 0.080% | 100 | 11.97 | 1.676 | Invention |
| | | | | | | | | | | | example |
| 4F | 150 | 9 | 5 | 1.8 | 1.8 | 0.070% | 0.135% | 60 | 13.88 | 1.669 | Invention |
| | | | | | | | | | | | example |
| 4G | 180 | 7 | 6 | 1.4 | 2.1 | 0.110% | 0.130% | 100 | 10.07 | 1.651 | Invention |
| | | | | | | | | | | | example |
| 4H | 190 | 5 | 7 | 1.0 | 2.5 | 0.120% | 0.115% | 100 | 11.97 | 1.676 | Invention |
| | | | | | | | | | | | example |
| 4I | 180 | 6 | 5 | 1.2 | 1.8 | 0.115% | 0.100% | 100 | 11.97 | 1.652 | Invention |
| | | | | | | | | | | | example |
| 4J | 160 | 9 | 7 | 1.8 | 2.5 | 0.090% | 0.175% | 75 | 13.89 | 1.673 | Invention |
| | | | | | | | | | | | example |
| 4K | 180 | 6 | 5 | 1.2 | 1.8 | 0.110% | 0.100% | 100 | 11.97 | 1.686 | Invention |
| | | | | | | | | | | | example |
| 4L | 180 | 5 | 6 | 1.0 | 2.1 | 0.100% | 0.100% | 100 | 11.97 | 1.686 | Invention |
| | | | | | | | | | | | example |
| 4M | 185 | 6 | 4 | 1.2 | 1.4 | 0.110% | 0.080% | 100 | 11.97 | 1.676 | Invention |
| | | | | | | | | | | | example |
| 4N | 160 | 8 | 5 | 1.6 | 1.8 | 0.080% | 0.125% | 70 | 13.90 | 1.676 | Invention |
| | | | | | | | | | | | example |
| 4O | 170 | 5 | 7 | 1.0 | 2.5 | 0.080% | 0.115% | 75 | 13.92 | 1.668 | Invention |
| | | | | | | | | | | | example |
| 4P | 160 | 8 | 9 | 1.6 | 3.2 | 0.075% | 0.195% | 80 | 13.87 | 1.672 | Invention |
| | | | | | | | | | | | example |
| 4Q | 165 | 7 | 6 | 1.4 | 2.1 | 0.070% | 0.130% | 75 | 13.93 | 1.668 | Invention |
| | | | | | | | | | | | example |
| 4R | 150 | 8 | 5 | 1.6 | 1.8 | 0.060% | 0.125% | 60 | 13.96 | 1.664 | Invention |
| | | | | | | | | | | | example |
| 4S | 180 | 6 | 7 | 1.2 | 2.5 | 0.110% | 0.130% | 75 | 13.83 | 1.672 | Invention |
| | | | | | | | | | | | example |

*1: area proportion of crystal grains having crystal grain size of less than 200 μm when boundary with crystal orientation difference of 2° or more and less than 15° is regarded as crystal grain boundary,

### BRIEF DESCRIPTION OF THE REFERENCE SYMBOLS

21 Stator core
22 Core back
23 Teeth
30 Rotor core
31 Rotor iron core
32 Magnets
50 Case
60 Shaft

1. A non-oriented electrical steel sheet,
wherein an area proportion of crystal grains having a crystal grain size of less than 200 μm is 10% or lower when a boundary with a crystal orientation difference of 2° or more and less than 15° is regarded as a crystal grain boundary in a cross section parallel to a steel sheet surface.

2. The non-oriented electrical steel sheet according to claim 1,
wherein equation (1) below is satisfied when a maximum crystal grain size when a boundary with a crystal orientation difference of 15° or more is regarded as a crystal grain boundary is regarded as D15_{MAX} and an average crystal grain size when a boundary with a crystal orientation difference of 2° or more is regarded as a crystal grain boundary is regarded as D2_{AVE} in a cross section parallel to a steel sheet surface,
D15_{MAX}/D2_{AVE}≤5.0 (1).

3. The non-oriented electrical steel sheet according to claim 1,
wherein equation (2) below is satisfied when a boundary with a crystal orientation difference of 15° or more is regarded as a crystal grain boundary in a cross section parallel to a steel sheet surface and when a major axis length is regarded as DL and a minor axis length is regarded as DC in a shape obtained by approximating shapes of crystal grains having a crystal grain size of 200 μm or more with ellipses,
DL/DC≤5.0 (2).

4. The non-oriented electrical steel sheet according to claim 1,
wherein the non-oriented electrical steel sheet has a chemical composition containing, by mass %,
C: 0% to 0.0050%,
Si: 2.00% to 3.25%,
Sol. Al: 0% to 1.10%,
Mn: 0% to 1.10%,
P: 0% to 0.30%,
S: 0% to 0.0100%,
N: 0% to 0.0100%,
Ti: 0% to 0.1000%,
V: 0% to 0.100%,
Zr: 0% to 0.100%,
Nb: 0% to 0.100%,
B: 0% to 0.100%,
O: 0% to 0.100%,
Mg: 0% to 0.100%,
Ca: 0% to 0.010%,
Cr: 0% to 5.000%,
Ni: 0% to 5.000%,
Cu: 0% to 5.000%,
Sn: 0% to 0.100%,
Sb: 0% to 0.100%,
Ce: 0% to 0.100%,
Nd: 0% to 0.100%,
Bi: 0% to 0.100%,
W: 0% to 0.100%,
Mo: 0% to 0.100%, and
Y: 0% to 0.100%,
with the balance consisting of Fe and impurities,
wherein a sheet thickness is 0.10 mm to 0.35 mm, and
wherein an average crystal grain size is 10 μm to 200 μm.

5. The non-oriented electrical steel sheet according to claim 2,
wherein the non-oriented electrical steel sheet has a chemical composition containing, by mass %,
C: 0% to 0.0050%,
Si: 2.00% to 3.25%,
Sol. Al: 0% to 1.10%,
Mn: 0% to 1.10%,
P: 0% to 0.30%,
S: 0% to 0.0100%,
N: 0% to 0.0100%,
Ti: 0% to 0.1000%,
V: 0% to 0.100%,
Zr: 0% to 0.100%,
Nb: 0% to 0.100%,
B: 0% to 0.100%,
O: 0% to 0.100%,
Mg: 0% to 0.100%,
Ca: 0% to 0.010%,
Cr: 0% to 5.000%,
Ni: 0% to 5.000%,
Cu: 0% to 5.000%,
Sn: 0% to 0.100%,
Sb: 0% to 0.100%,
Ce: 0% to 0.100%,
Nd: 0% to 0.100%,
Bi: 0% to 0.100%,
W: 0% to 0.100%,
Mo: 0% to 0.100%, and
Y: 0% to 0.100%,
with the balance consisting of Fe and impurities,
wherein a sheet thickness is 0.10 mm to 0.35 mm, and
wherein an average crystal grain size is 10 μm to 200 μm.

6. The non-oriented electrical steel sheet according to claim 3,
wherein the non-oriented electrical steel sheet has a chemical composition containing, by mass %,
C: 0% to 0.0050%,
Si: 2.00% to 3.25%,
Sol. Al: 0% to 1.10%,
Mn: 0% to 1.10%,
P: 0% to 0.30%,
S: 0% to 0.0100%,
N: 0% to 0.0100%,
Ti: 0% to 0.1000%,
V: 0% to 0.100%,
Zr: 0% to 0.100%,
Nb: 0% to 0.100%,
B: 0% to 0.100%,
O: 0% to 0.100%,
Mg: 0% to 0.100%,
Ca: 0% to 0.010%,
Cr: 0% to 5.000%,
Ni: 0% to 5.000%,
Cu: 0% to 5.000%,
Sn: 0% to 0.100%,
Sb: 0% to 0.100%,
Ce: 0% to 0.100%,
Nd: 0% to 0.100%,
Bi: 0% to 0.100%,
W: 0% to 0.100%,
Mo: 0% to 0.100%, and
Y: 0% to 0.100%,
with the balance consisting of Fe and impurities,
wherein a sheet thickness is 0.10 mm to 0.35 mm, and
wherein an average crystal grain size is 10 μm to 200 μm.

7. The non-oriented electrical steel sheet according to claim 2,
wherein equation (2) below is satisfied when a boundary with a crystal orientation difference of 15° or more is regarded as a crystal grain boundary in a cross section parallel to a steel sheet surface and when a major axis length is regarded as DL and a minor axis length is regarded as DC in a shape obtained by approximating shapes of crystal grains having a crystal grain size of 200 μm or more with ellipses,
DL/DC≤5.0 (2).

8. The non-oriented electrical steel sheet according to claim 2,
wherein the non-oriented electrical steel sheet has a chemical composition containing, by mass %,
C: 0% to 0.0050%,
Si: 2.00% to 3.25%,
Sol. Al: 0% to 1.10%,
Mn: 0% to 1.10%,
P: 0% to 0.30%,
S: 0% to 0.0100%,
N: 0% to 0.0100%,
Ti: 0% to 0.1000%,
V: 0% to 0.100%,
Zr: 0% to 0.100%,
Nb: 0% to 0.100%,
B: 0% to 0.100%,
O: 0% to 0.100%,
Mg: 0% to 0.100%,
Ca: 0% to 0.010%,
Cr: 0% to 5.000%,
Ni: 0% to 5.000%,
Cu: 0% to 5.000%,
Sn: 0% to 0.100%,
Sb: 0% to 0.100%,
Ce: 0% to 0.100%,
Nd: 0% to 0.100%,
Bi: 0% to 0.100%,
W: 0% to 0.100%,
Mo: 0% to 0.100%, and
Y: 0% to 0.100%,
with the balance comprising Fe and impurities,
wherein a sheet thickness is 0.10 mm to 0.35 mm, and
wherein an average crystal grain size is 10 μm to 200 μm.
